(19) United States
(12) Patent Application Publication
(10) Pub. No.: US 2025/0307973 A1
(43) Pub. Date: Oct. 2, 2025

(54) DISPLAY SCREEN SAVING METHOD AND DISPLAY SYSTEM

(71) Applicant: SEIKO EPSON CORPORATION, Tokyo (JP)

(72) Inventors: Kohei SUZUKI, MATSUMOTO-SHI (JP); Shun UEDA, MATSUMOTO-SHI (JP); Katsuyoshi YAMAGUCHI, MATSUMOTO-SHI (JP)

(21) Appl. No.: 19/083,552

(22) Filed: Mar. 19, 2025

(30) Foreign Application Priority Data
Mar. 26, 2024 (JP) 2024-048992

(51) Int. Cl. G06T 1/00; G06T 1/60; G06T 11/20; G06T 11/60; G06V 30/32

(52) U.S. Cl. CPC G06T 1/0007; G06T 1/60; G06T 11/203; G06T 11/60; G06V 30/32

(57) ABSTRACT

Receiving a capture request by a projector 100, capturing a projection image by the projector 100 to generate first save data, transmitting the first save data to an information processing terminal 200 by the projector 100, saving the first save data in an AP file 265 by the information processing terminal 200, receiving a capture request by the projector 100, capturing a projection image by the projector 100 to generate second save data, transmitting the second save data to the information processing terminal 200 by the projector 100, and saving the second save data in the AP file 265 by the information processing terminal 200 are performed.

The present application is based on, and claims priority from JP Application Serial Number 2024-048992, filed Mar. 26, 2024, the disclosure of which is hereby incorporated by reference herein in its entirety.

### BACKGROUND

### 1. Technical Field

The present disclosure relates to a display screen saving method and a display system.

### 2. Related Art

In the related art, a system has been known in which a display image based on image data is displayed on a display surface or a drawn image such as a line or a figure at a position of the display surface indicated by an indicator such as an electronic pen.

For example, an image supply device disclosed in JP-A-2012-194850 detects an indication position of an indicator that is a pen-type device based on data received from a projector and draws a line or a figure along a trajectory of the detected positions.

For example, there is a need to save the display image displayed on the display surface by a display or a note drawn by a user on the display surface using the indicator in a file and to view the display image or the note later. However, when a capture command is saved as a separate file each time the user inputs the capture command, or when the display image and the drawn image are saved separately, the workload on the user may increase when integrating the files into a format that is easy for the user to view.

### SUMMARY

An aspect of the present disclosure is a display screen saving method including: receiving, by a display, a capture request for a first screen displayed on a display surface by the display; capturing the first screen by the display to generate first data; transmitting the first data to an information processing terminal by the display; saving the first data in a first application file by the information processing terminal; receiving, by the display, a capture request for a second screen displayed on the display surface by the display; capturing the second screen by the display to generate second data; transmitting the second data to the information processing terminal by the display; and saving the second data in the first application file by the information processing terminal.

Another aspect of the present disclosure is a display system including: an information processing terminal; and a display configured to display a display screen on a display surface, in which the display includes a first communicator, a receiver configured to receive an operation, an optical device configured to display the display screen on the display surface, and a first controller configured to receive, by the receiver, a capture request for a first screen displayed on the display surface by the optical device, capture the first screen to generate first data, transmit the first data to the information processing terminal by the first communicator, receive, by the receiver, a capture request for a second screen displayed on the display surface by the optical device, capture the second screen to generate second data, and transmit the second data to the information processing terminal by the first communicator, and the information processing terminal includes a second communicator, and a second controller configured to save the first data received from the display by the second communicator in a first application file and store the second data received from the display by the second communicator in the first application file.

### BRIEF DESCRIPTION OF THE DRAWINGS

FIG. 1 is a diagram illustrating a system configuration of a display system.

FIG. 2 is a block diagram illustrating a configuration of a projector.

FIG. 3 is a block diagram illustrating a configuration of an information processing terminal.

FIG. 4 is a diagram illustrating an example of a display surface.

FIG. 5 is a flowchart illustrating operations of the projector.

FIG. 6 is a flowchart illustrating operations of the information processing terminal.

### DESCRIPTION OF EMBODIMENTS

### 1. Configuration of Display System According to First Embodiment

Hereinafter, a first embodiment will be described with reference to the accompanying drawings.

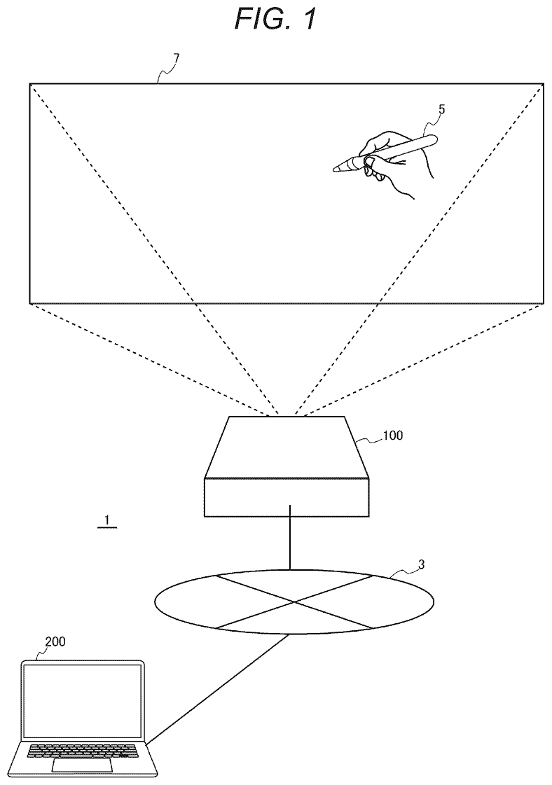

FIG. 1 is a diagram illustrating a system configuration of a display system 1.

The display system 1 includes a projector 100 and an information processing terminal 200.

The projector 100 and the information processing terminal 200 are coupled via a communication network 3. FIG. 1 illustrates an example in which the information processing terminal 200 and the projector 100 are coupled to the communication network 3 by wire. However, the projector 100 and the information processing terminal 200 may be coupled to the communication network 3 wirelessly. Examples of the communication network 3 include a local area network (LAN) and a wide area network (WAN).

The projector 100 displays an image based on image data supplied by the information processing terminal 200 on a display surface 7. The projector 100 generates image light based on the image data supplied by the information processing terminal 200. The projector 100 projects the generated image light onto the display surface 7. Accordingly, an image corresponding to the image data is displayed on the display surface 7. The image corresponding to the image data is referred to as a display image 31.

The projector 100 detects an operation of an indicator 5 on the display surface 7 and displays a line image at a position on the display surface 7 where the operation is detected. The indicator 5 is an electronic pen including a light emitter that emits infrared light and a pressing detector that detects pressing of a tip end of the indicator 5 against the display surface 7, that is, a touch on the display surface 7. Examples of the pressing detector include a pressure-sensitive switch. Illustration of the light emitter and the pressing detector is omitted. The light emitter repeats blinking in a predetermined light emission sequence while the indicator 5 is operating. The light emitter changes the light emission sequence according to whether there is a touch on the display surface 7. Therefore, the projector 100 can identify the presence or absence of the touch by the indicator 5 based on the light emission sequence of the light emitter.

The projector 100 includes an image-capturing unit 160 whose angle of view is adjusted such that an image of at least a part of the display surface 7 can be captured. The projector 100 detects the light emitted by the indicator 5 from a captured image of the image-capturing unit 160, and detects a position of the detected light as an indication position indicated by the indicator 5. The projector 100 detects the presence or absence of a touch on the display surface 7 based on a light emission sequence of the detected light. The projector 100 generates drawing data that is data of a line image corresponding to a trajectory of the detected indication position, and displays the generated drawing data on the display surface 7.

The information processing terminal 200 supplies the image data to be displayed by the projector 100 to the projector 100. Examples of the information processing terminal 200 include a desktop, notebook, or tablet personal computer and a portable terminal such as a smartphone.

### 2. Configuration of Projector According to First Embodiment

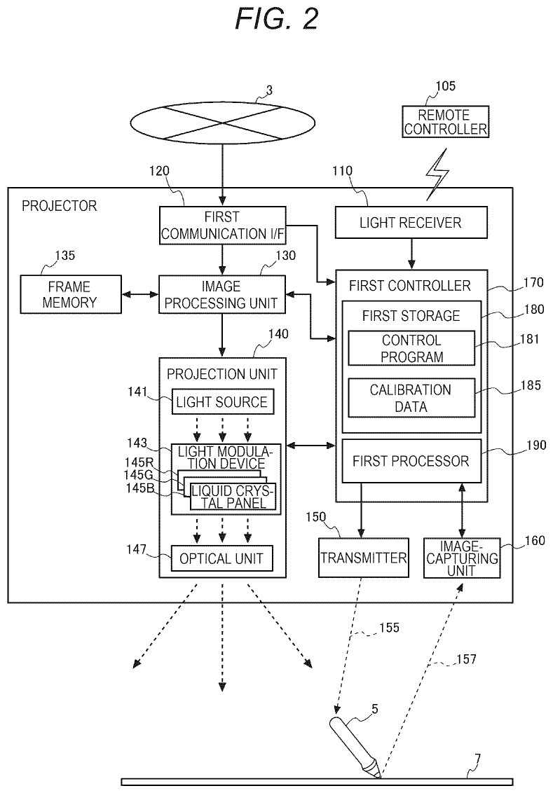

FIG. 2 is a block diagram illustrating a configuration of the projector 100.

The configuration of the projector 100 will be described with reference to FIG. 2.

The projector 100 includes a light receiver 110, a first communication interface 120, an image processing unit 130, a frame memory 135, a projection unit 140, a transmitter 150, the image-capturing unit 160, and a first controller 170. Hereinafter, the interface is abbreviated as an I/F.

The light receiver 110 receives an infrared signal transmitted from a remote controller 105. The light receiver 110 outputs an operation signal corresponding to the received infrared signal to the first controller 170. The operation signal is a signal s corresponding to an operated switch of the remote controller 105.

The first communication I/F 120 includes, for example, a communication card such as a network interface card (NIC), and performs data communication with the information processing terminal 200 via the communication network 3.

The frame memory 135 is coupled to the image processing unit 130. The frame memory 135 includes plurality of banks. Each of the banks has a storage capacity that enables the writing of image data for one frame. The frame memory 135 is implemented by, for example, a synchronous dynamic RAM (SDRAM). The image processing unit 130 loads the image data input from the first communication I/F 120 onto the frame memory 135.

The image processing unit 130 performs image processing on the image data loaded onto the frame memory 135. Examples of the image processing performed by the image processing unit 130 include resolution conversion processing, resizing processing, distortion aberration correction, shape correction processing, digital zoom processing, and adjustment of an image color tone and luminance. The image processing unit 130 executes processing designated by the first controller 170, and executes the processing by using a parameter input from the first controller 170 as necessary. The image processing unit 130 can of course execute a combination of the plurality of pieces of the image processing described above. When the image processing ends, the image processing unit 130 reads the data loaded on the frame memory 135 as display data and outputs the read display data to a panel driving unit of a light modulation device 143. The illustration of the panel driving unit is omitted.

The image processing unit 130 and the frame memory 135 are implemented by, for example, an integrated circuit. Examples of the integrated circuit include a large scale integration (LSI), an application specific integrated circuit (ASIC), a programmable logic device (PLD), a field-programmable gate array (FPGA), and a system-on-a-chip (SoC). An analog circuit may be included in a part of a configuration of the integrated circuit, and the first controller 170 and the integrated circuit may be combined.

The projection unit 140 includes a light source 141, the light modulation device 143, and an optical unit 147.

The light source 141 includes a discharge-type light source lamp such as an extra-high pressure mercury lamp or a metal halide lamp, or a solid light source such as a light-emitting diode or a semiconductor laser. Light emitted from the light source 141 is separated into red light, green light, and blue light by a color separation optical system (not illustrated).

The light modulation device 143 includes three liquid crystal panels 145R, 145G, and 145B corresponding to red, green, and blue color components. Hereinafter, the liquid crystal panels 145R, 145G, and 145B are collectively referred to as a liquid crystal panel 145. The color light separated into the red, green, and blue color components by the color separation optical system is incident on the liquid crystal panels 145R, 145G, and 145B, respectively.

Each of the liquid crystal panels 145R, 145G, and 145B is implemented by a transmissive liquid crystal panel in which liquid crystal is sealed between a pair of transparent substrates. In the liquid crystal panel, a pixel area formed of a plurality of pixels arranged in a matrix shape is formed, and a drive voltage can be applied to the liquid crystal for each pixel.

The light modulation device 143 includes the panel driving unit that drives the liquid crystal panels 145R, 145G, and 145B. The panel driving unit applies a drive voltage corresponding to the input display data to each pixel in the pixel area and sets each pixel to a light transmittance corresponding to the display data. The light emitted from the light source 141 is modulated for each pixel by passing through the pixel area of the liquid crystal panel, and image light corresponding to the display data is formed for each color light. The formed image light of each color is combined for each pixel by a color combining optical system (not illustrated) to become image light representing a color image. The optical unit 147 includes a projection lens and enlarges and projects the image light modulated by the liquid crystal panel 145 onto the display surface 7. Accordingly, the display image 31 based on the image data is displayed on the display surface 7.

The transmitter 150 includes, for example, a light source such as an LED and a device that controls turning on and turning off of the light source. The device that performs control can be implemented by, for example, an ASIC, an FPGA, or the like.

The transmitter 150 outputs first signal light 155 that is a signal for synchronizing a light emission timing of the indicator 5 with an image-capturing timing of the image-capturing unit 160. The first signal light 155 is a near-infrared light signal that can be received by the indicator 5. The transmitter 150 periodically transmits the first signal light 155 while the projector 100 is in operation.

The first signal light 155 is a control signal indicating a timing of causing the indicator 5 to transmit second signal light 157. The first signal light 155 is near-infrared light having a predetermined light emission pattern. For example, the indicator 5 emits the second signal light 157 in synchronization with a timing at which the first signal light 155 is received. The projector 100 causes the image-capturing unit 160 to execute image capturing at a timing at which the indicator 5 emits the second signal light 157.

The image-capturing unit 160 is a camera including an image-capturing element (not illustrated) such as a charge coupled device (CCD) sensor or a complementary metal oxide semiconductor (CMOS) sensor. The image-capturing unit 160 includes an infrared transmission filter that absorbs visible light and transmits infrared light, and captures an image of the infrared light emitted from the indicator 5 via the infrared transmission filter. The image-capturing unit 160 repeats capturing images of the display surface 7 under the control of the first controller 170 and sequentially outputs the captured images, which are image-capturing results, to the first controller 170.

The first controller 170 is a computer device including a first storage 180 and a first processor 190.

The first storage 180 includes a memory such as a random access memory (RAM) and a read only memory (ROM). The RAM is used to temporarily store various types of data and the like. The ROM stores control programs for controlling operations of the projector 100, various types of setting information, and the like.

The first storage 180 stores a control program 181 and calibration data 185.

The control program 181 is a program such as firmware or an application program executed by the first processor 190.

The calibration data 185 is data that associates coordinates of the captured image of the image-capturing unit 160 with coordinates of the frame memory 135. A two-dimensional coordinate system is set in the captured image and the frame memory 135, and the coordinates of the frame memory 135 corresponding to the coordinates on the captured image are uniquely specified by the calibration data 185.

The first processor 190 is an arithmetic processing device implemented by a central processing unit (CPU) or a micro processing unit (MPU). The first processor 190 executes the control program 181 to control each unit of the projector 100. The first processor 190 may be implemented by a single processor or a plurality of processors. The first processor 190 may be implemented by a Soc integrated with a part or all of the first storage 180 or with other circuits. The first processor 190 may be implemented by a combination of a CPU that executes a program and a DSP that executes predetermined arithmetic processing. The first processor 190 may be implemented by implementing all of the functions thereof in hardware, or may be implemented using a programmable device.

The first controller 170 detects the infrared light emitted by the indicator 5 from the captured image input from the image-capturing unit 160. The first controller 170 considers an infrared light image included in the captured image that has a brightness equal to or larger than a predetermined threshold and a size within a predetermined range to be light emitted by the indicator 5. The first controller 170 detects the indication position of the indicator 5 based on the position of the light emitted by the indicator 5 in the captured image. The first controller 170 determines the light emission sequence of the indicator 5 based on the captured images acquired a plurality of times and detects the presence or absence of a touch on the display surface 7.

The first controller 170 generates the drawing data in which a line is drawn along the trajectory of the indication position based on a detection result of the indication position. For example, when a user performs a drawing operation of drawing on the display surface 7 with the indicator 5, that is, when the indication position changes in a state where the indicator 5 is in touch with the display surface 7, the first controller 170 generates the drawing data based on the trajectory of the indication position.

### 3. Configuration of Information Processing Terminal According to First Embodiment

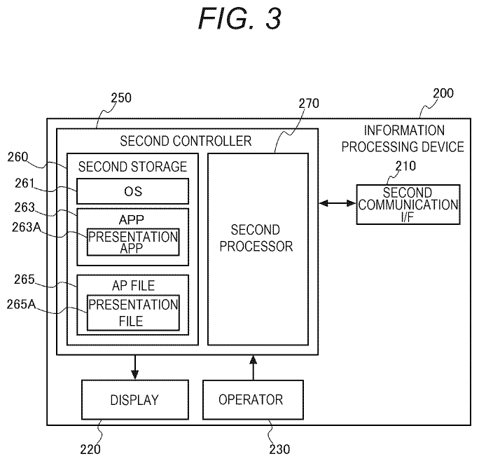

FIG. 3 is a block diagram illustrating a configuration of the information processing terminal 200. The configuration of the information processing terminal 200 will be described with reference to FIG. 3.

The information processing terminal 200 includes a second communication I/F 210, a display 220, an operator 230, and a second controller 250.

The second communication I/F 210 includes, for example, a communication card such as an NIC, and performs data communication with the projector 100 via the communication network 3.

The display 220 includes, for example, a display panel such as a liquid crystal panel or an organic electro luminescence (EL) panel, and displays an image based on image data input from the second controller 250 on the display panel. The display 220 may be implemented by a touch panel.

The operator 230 includes an input device such as a mouse or a keyboard, and receives operations of the user. The operator 230 outputs an operation signal corresponding to the received operation to the second controller 250. When the operation signal is input from the operator 230, the second controller 250 determines that an operation is received.

The second controller 250 includes a second storage 260 and a second processor 270.

The second storage 260 includes a volatile memory such as an RAM and a nonvolatile memory such as an ROM. The second storage 260 includes an auxiliary storage device such as a solid state drive (SSD) or a hard disk drive (HDD).

The second storage 260 stores an operating system (OS) 261 executed by the second processor 270 and a control program such as an application program 263. Hereinafter, the application program 263 will be referred to as an APP 263. The APP 263 includes, for example, application programs for documents such as Word, Excel, and PowerPoint.

The second storage 260 stores an application file 265. Hereinafter, the application file is referred to as an AP file 265. The AP file 265 is generated by the second processor 270 that executes the APP 263, and is stored in the second storage 260.

The second processor 270 is an arithmetic processing device implemented by a CPU or an MPU. The second processor 270 may be implemented by a single processor or a plurality of processors. The second processor 270 may be implemented by an SoC integrated with a part or all of the second storage 260 or with other circuits. The second processor 270 may be implemented by a combination of a CPU that executes a program and a DSP that executes predetermined arithmetic processing. The second processor 270 may be implemented by implementing all of the functions thereof in hardware, or may be implemented using a programmable device.

### 4. Operations of Projector and Information Processing Terminal According to First Embodiment

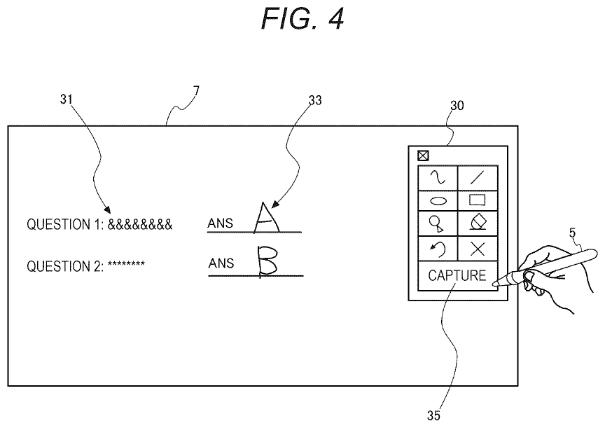

FIG. 4 illustrates an example of a projection image displayed on the display surface 7. The projection image is an image displayed by projecting the image light onto the display surface 7 by the projector 100, and includes the display image 31, a drawn image 33, a menu image 30 of on screen display (OSD), and the like. The projection image corresponds to a first screen and a second screen. The projection image displayed on the display surface 7 when a capture operation to be described later is received is the first screen and the second screen. More specifically, the projection image displayed on the display surface 7 when the capture operation is received for the first time corresponds to the first screen, and the projection image displayed on the display surface 7 when the capture operation is received for the second time corresponds to the second screen.

The drawn image 33 is an image corresponding to the trajectory of the indication position indicated by the indicator 5 which is used by the user. The first controller 170 analyzes the captured image captured by the image-capturing unit 160 to detect the indication position indicated by the indicator 5. The first controller 170 generates the drawing data, which is data of the line image corresponding to the trajectory of the detected indication position, and outputs the generated drawing data to the image processing unit 130. The image processing unit 130 superimposes the drawing data on the frame memory 135 onto which the image data is loaded, and outputs the data loaded on the frame memory 135 to the panel driving unit of the light modulation device 143 as the display data. Accordingly, the display image 31 and the drawn image 33 are displayed on the display surface 7.

The menu image 30 includes, for example, an icon for receiving an operation of changing a thickness, a color, or the like of a line drawn by the indicator 5. In the menu image 30, a capture icon 35 for instructing a capture of the display image displayed on the display surface 7 is displayed.

When instructing the projector 100 to capture, the user superimposes the tip end of the indicator 5 on the capture icon 35 and stops moving the indicator 5 superimposed on the capture icon 35 for a certain period of time. When the tip end of the indicator 5 is superimposed on a display position of the capture icon 35 for a certain period of time, the first controller 170 determines that the capture operation is received and instructs the image processing unit 130 to generate capture data.

When receiving the capture operation, the first controller 170 instructs the image processing unit 130 to capture the image loaded onto the frame memory 135.

The image processing unit 130 captures the frame memory 135 onto which the display image 31 based on the image data and the drawn image 33 based on the drawing data are loaded to generate the capture data. The capture data includes the display image 31 and the drawn image 33. The image processing unit 130 outputs the generated capture data to the first controller 170.

The first controller 170 generates save data to be transmitted to the information processing terminal 200 based on the capture data input from the image processing unit 130.

When the capture data input from the image processing unit 130 includes the display image 31 and the drawn image 33, the first controller 170 transmits the capture data to the information processing terminal 200 as the save data.

Every time it is determined that the capture operation is received, the first controller 170 generates the save data. For example, save data generated when the capture operation is received for the first time is referred to as first save data, and save data generated when the capture operation is received for the second time is referred to as second save data. The first save data corresponds to first data, and the second save data corresponds to second data. Hereinafter, similarly, save data generated when the capture operation is input for the N-th (N is any natural number) is referred to as N-th save data.

Next, operations of the information processing terminal 200 will be described.

The second controller 250 receives the save data transmitted by the projector 100 by the second communication I/F 210.

When receiving the save data, the second controller 250 determines whether the preset APP 263 is activated. In the embodiment, the description will be given on the assumption that the preset APP 263 is an application program for presentation such as PowerPoint, but may be an application program for documents such as Word or Excel. Hereinafter, the application program for presentation is referred to as a presentation APP 263A.

When the presentation APP 263A is not activated, the second controller 250 activates the presentation APP 263A and pastes the capture data included in the received save data to the AP file 265. The AP file 265 generated by the presentation APP 263A is referred to as a presentation file 265A. The presentation file 265A corresponds to a first application file.

For example, it is assumed that the second save data is received after the first save data is received from the projector 100. In this case, the second controller 250 acquires the capture data included in the received first save data, and saves the acquired capture data in the presentation file 265A. When the second save data is received from the projector 100 after saving the capture data included in the first save data in the presentation file 265A, the second controller 250 acquires the capture data included in the second save data. The second controller 250 saves the acquired capture data in the same presentation file 265A.

When receiving an operation of saving the presentation file 265A by the operator 230, the second controller 250 stores the presentation file 265A in the second storage 260.

While the projector 100 and the information processing terminal 200 are coupled to the communication network 3, the second controller 250 continues to save the capture data included in the save data in the same presentation file 265A. That is, even when the operation of saving the presentation file 265A is received by the operator 230 and the display of the presentation file 265A is deleted from the display 220, the second controller 250 saves the capture data included in the received save data in the same presentation file 265A when receiving the save data from the projector 100.

In the embodiment, a case where the capture data is saved in the same presentation file 265A while the projector 100 and the information processing terminal 200 are coupled to the communication network 3 is described. The capture data may be saved in different presentation files 265A. For example, after an operation of saving the presentation file 265A is received by an operation of the user and the presentation file 265A is stored in the second storage 260, when new save data is received, capture data included in the save data may be saved in a new presentation file 265A. The new presentation file 265A corresponds to a second application file. When the projector 100 generates the save data, the projection image displayed on the display surface 7 corresponds to a third screen, and the capture data generated by capturing the projection image corresponding to the third screen corresponds to third data.

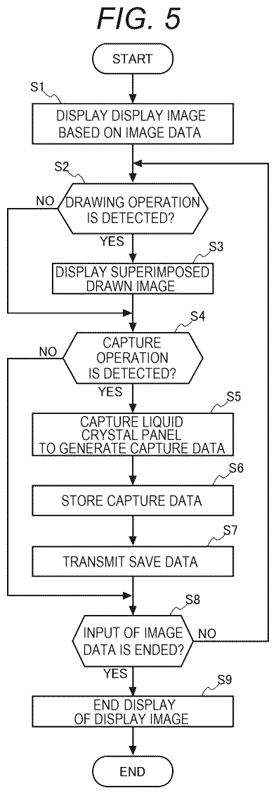

FIG. 5 is a flowchart illustrating operations of the projector 100.

The operations of the projector 100 will be described with reference to the flowchart illustrated in FIG. 5.

First, when receiving the image data from the information processing terminal 200, the first controller 170 generates the image light based on the received image data and projects the generated image light onto the display surface 7. Accordingly, the display image based on the image data is displayed on the display surface 7 (step S1).

Next, the first controller 170 determines whether the drawing operation by the indicator 5 is detected. That is, the first controller 170 determines, based on the captured image of the image-capturing unit 160, whether the drawing operation of bringing the tip end of the indicator 5 into contact with the display surface 7 and moving the tip end of the indicator 5 on the display surface 7 is detected.

When the drawing operation is detected (YES in step S2), the first controller 170 generates the drawing data, which is data of the line image corresponding to the trajectory of the indication position where the tip end of the indicator 5 is in contact with the display surface 7. The first controller 170 displays the drawn image 33, which is based on the generated drawing data, superimposed on the display image (step S3).

When the drawing operation is not detected (NO in step S2) or when the drawn image 33 is displayed on the display surface 7 (step S3), the first controller 170 determines whether the capture operation is detected (step S4).

When the capture operation is detected (YES in step S4), the first controller 170 captures the image loaded onto the liquid crystal panel 145 to generate the capture data (step S5). The image loaded onto the liquid crystal panel 145 includes the display image and the drawn image 33.

Next, the first controller 170 stores the generated capture data in the first storage 180 (step S6).

Next, the first controller 170 transmits the save data including the capture data to the information processing terminal 200 (step S7).

Here, when the capture operation is detected a plurality of times, the save data is transmitted from the projector 100 to the information processing terminal 200 a plurality of times. Hereinafter, for convenience of description, the capture data included in the save data that is first transmitted from the projector 100 to the information processing terminal 200 is referred to as first capture data. The capture data included in the save data that is transmitted from the projector 100 to the information processing terminal 200 for the second time is referred to as second capture data. The first capture data includes a first display image, and the second capture data includes a second display image.

Next, the first controller determines whether the input of the image data is ended (step S8). When the input of the image data is not ended (NO in step S8), the first controller 170 returns to step S2 and determines whether a drawing operation is detected from the captured image of the image-capturing unit 160. When the input of the image data is ended (YES in step S8), the first controller 170 ends the display of the display image 31 on the display surface 7 (step S9).

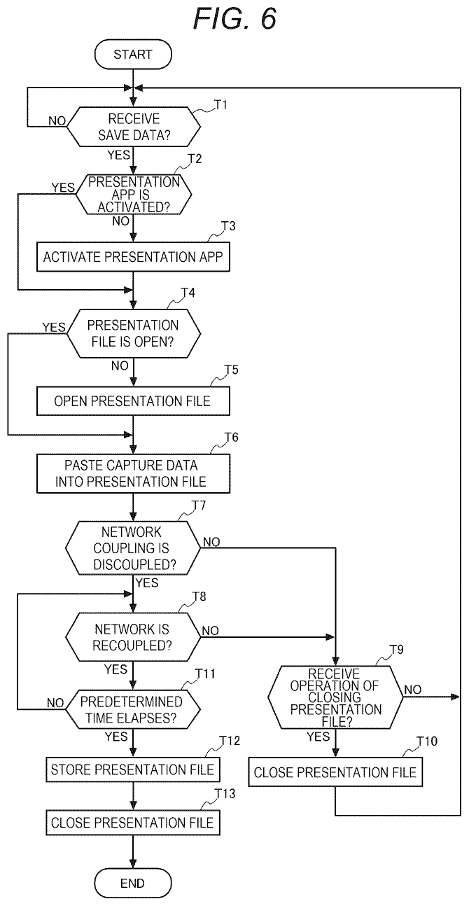

FIG. 6 is a flowchart illustrating the operations of the information processing terminal 200.

The operations of the information processing terminal 200 will be described with reference to the flowchart illustrated in FIG. 6.

The second controller 250 determines whether the save data is received from the projector 100 (step T1). When the save data is not received (NO in step T1), the second controller 250 waits until the save data is received.

When the save data is received (YES in step T1), the second controller 250 determines whether the presentation APP 263A is activated (step T2). When the presentation APP 263A is not activated (NO in step T2), the second controller 250 activates the presentation APP 263A (step T3).

Next, the second controller 250 determines whether the presentation file 265A is open (step T4). When the presentation file 265A is not open (NO in step T4), the second controller 250 opens the presentation file 265A (step T5).

Next, the second controller 250 acquires the capture data included in the received save data and pastes the acquired capture data into the presentation file 265A (step T6).

Next, the second controller 250 determines whether the network coupling with the communication network 3 is discoupled (step T7). When the network coupling with the communication network 3 is discoupled (YES in step T7), the second controller 250 determines whether the network with the communication network 3 is recoupled (step T8).

When the network with the communication network 3 is not recoupled (NO in step T8), the second controller 250 determines whether an operation of closing the presentation file 265A is received (step T9). When the operation of closing the file is not received (NO in step T9), the second controller 250 returns to the determination in step T1. When the operation of closing the presentation file 265A is received (YES in step T9), the second controller 250 stores the presentation file 265A in the second storage 260 (step T10) and closes the presentation file 265A. Thereafter, the second controller 250 returns to the determination in step T1 and determines whether the save data is received.

When the network with the communication network 3 is recoupled (YES in step T8), the second controller 250 determines whether a predetermined time elapses since the network coupling with the communication network 3 is discoupled (step T11). When the predetermined time does not elapse since the network coupling with the communication network 3 is discoupled (NO in step T11), the second controller 250 returns to the determination in step T8.

When the predetermined time elapses since the network coupling with the communication network 3 is discoupled (YES in step T11), the second controller 250 stores the presentation file 265A in the second storage 260 (step T12), closes the presentation file 265A (step T13), and ends this processing flow.

When the network coupling is not discoupled (NO in step T7), the second controller 250 determines whether the operation of closing the presentation file 265A is received (step T9). When the operation of closing the file is not received (NO in step T9), the second controller 250 returns to the determination in step T1. When the operation of closing the presentation file 265A is received (YES in step T9), the second controller 250 stores the presentation file 265A in the second storage 260 (step T10) and closes the presentation file 265A. Thereafter, the second controller 250 returns to the determination in step T1 and determines whether the save data is received.

### 5. Second Embodiment

A second embodiment will be described with reference to the accompanying drawings.

Since a configuration of the display system 1 according to the second embodiment is the same as that of the above-described first embodiment, the description of the configuration of the display system 1 will be omitted.

In the second embodiment, data obtained by capturing the drawn image 33 is not included in capture data generated by the first controller 170. The capture data according to the second embodiment includes only data obtained by capturing the display image 31 based on image data.

130 generates, The image processing unit according to an instruction of the first controller 170, the capture data obtained by capturing only the display image 31 based on the image data. The image processing unit 130 outputs the capture data obtained by capturing only the display image 31 to the first controller 170.

The first controller 170 generates save data including vector data and the data obtained by capturing the display image 31. The vector data is data of a point having coordinate values and is data obtained by converting drawing data generated by the first controller 170 based on a trajectory of an indication position of the indicator 5. The first controller 170 includes the vector data generated by the first controller 170 in the save data instead of the data obtained by capturing the drawn image 33. After generating the save data, the first controller 170 transmits the generated save data to the information processing terminal 200. The vector data corresponds to the drawing data. That is, the vector data included in the first save data corresponds to the first drawing data, and the vector data included in the second save data corresponds to the second drawing data.

When receiving the save data from the projector 100, the second controller 250 of the information processing terminal 200 acquires the capture data and the vector data which are included in the received save data. The second controller 250 converts the acquired vector data into object data. The object data is data capable of executing functions of the presentation APP 263A, such as size change including enlargement and reduction, color conversion, and the like. When the vector data is converted into the object data, the information processing terminal 200 pastes the capture data and the object data into the presentation file 265A in association with each other, and saves the capture data and the object data in the presentation file 265A.

When the drawing data is converted into the image data such as a bitmap and is pasted into the presentation file 265A, for example, a color of a background image pasted in advance into the presentation file 265A may be changed to white. In contrast, when the drawing data is converted into the vector data, since the vector data is coordinate data, the background image is not changed to white, and it is possible to prevent the background image from becoming invisible.

The second controller 250 determines whether the vector data acquired from the save data includes numbers, characters, symbols, or the like. When the vector data includes numbers, characters, and symbols, the information processing terminal 200 converts these pieces of data into text data. For example, when the vector data is a handwritten character, the second controller 250 detects the character from the vector data by character recognition processing, and converts the detected character into the text data.

The second controller 250 may save the capture data and the object data in a background without displaying the presentation file 265A on the display 220 when pasting the capture data and the object data into the presentation APP 263A and saving them. Accordingly, the user can display an image different from the display image 31 on the display 220. When the capture data and the object data are saved in the background, the information processing terminal 200 or the projector 100 coupled to the information processing terminal 200 may notify that the saving is ended. Accordingly, the user of the information processing terminal 200 can recognize that the saving of the data is completed.

The above-described embodiments are preferred embodiments according to the present disclosure. However, the present disclosure is not limited to the embodiments described above, and various modified implementations are possible within a range not departing from the gist of the present disclosure.

For example, the functional units of the projector 100 illustrated in FIG. 2 and the information processing terminal 200 illustrated in FIG. 3 indicate functional configurations, and specific implementation forms are not particularly limited. That is, there is no need to implement hardware that corresponds to each functional unit individually, and it is of course possible to implement a configuration in which one processor executes a program to implement the functions of a plurality of functional units. In the above-described embodiments, a part of the functions implemented by software may be implemented by hardware, and a part of the functions of the projector 100 or the information processing terminal 200, which is implemented by hardware, may be implemented by software. In addition, specific detailed configurations of the other units of the projector can be freely changed without departing from the gist of the present disclosure.

Processing units of the flowchart illustrated in FIG. 5 are divided according to main processing contents to facilitate understanding of the processing performed by the projector 100. Similarly, processing units of the flowchart illustrated in FIG. 6 are divided according to main processing contents to facilitate understanding of the processing performed by the information processing terminal 200. The present disclosure is not limited by the division method or names of processing units illustrated in the flowcharts in FIGS. 5 and 6. The processing performed by the first controller 170 of the projector 100 and the second controller 250 of the information processing terminal 200 may be divided into more processing units according to the processing contents, or may be devided such that one processing unit includes more processing. A processing order of the flowchart described above is not limited to the illustrated examples.

In the above-described embodiments, the liquid crystal panel 145 included in the light modulation device 143 may be a transmissive-type liquid crystal panel or may be a reflective-type liquid crystal panel. The light modulation device 143 may include a digital mirror device, or may include a combination of a digital mirror device and a color wheel. The light modulation device 143 may adopt a configuration capable of modulating the light emitted by the light source other than the liquid crystal panel and the DMD.

In the above-described embodiments, the projector 100 is used as the display, but the present disclosure is not limited thereto. For example, the display may be a display such as a liquid crystal display, an organic EL display, or a plasma display. When these displays are used, the display may be provided with the transmitter 150 and the image-capturing unit 160 described in the above embodiments to detect the position of the indicator 5, or a display surface such as a liquid crystal panel or an organic EL panel may be configured as a touch panel including a display panel and a touch sensor to detect a touch position on the display surface.

When the display screen saving method is implemented using a computer included in the projector 100 and a computer included in the information processing terminal 200, a program to be executed by the computers may be implemented in a form of a recording medium. Alternatively, it can also be implemented in a form of a transmission medium for transmitting the programs. As the recording medium, a magnetic or optical recording medium or a semiconductor memory device can be used. Specific examples of the recording medium include portable or immobile recording media such as a flexible disc, a hard disk drive (HDD), a CD-ROM, a digital versatile disc (DVD), a Blu-ray disc, a magneto-optical disk, a flash memory, and a card-shaped recording medium. The recording medium may be a nonvolatile storage device such as a RAM, a ROM, or an HDD that is an internal storage device provided in a server device. Blu-ray is a registered trademark.

In the above-described embodiments, the display image 31, the drawn image 33, the menu image 30 of OSD, and the like are included on the display surface 7, but the display image 31 may not be included. When the above-described capture operation is received, the drawn image 33 displayed on the display surface 7 becomes the first screen and the second screen.

### 6. Summary of Present Disclosure

The present disclosure will be summarized below in the form of appendixes.

### Appendix 1

A display screen saving method including: receiving, by a display, a capture request for a first screen displayed on a display surface by the display; capturing the first screen by the display to generate first data; transmitting the first data to an information processing terminal by the display; saving the first data in a first application file by the information processing terminal; receiving, by the display, a capture request for a second screen displayed on the display surface by the display; capturing the second screen by the display to generate second data; transmitting the second data to the information processing terminal by the display; and saving the second data in the first application file by the information processing terminal.

Accordingly, the first data obtained by capturing the first screen and the second data obtained by capturing the second screen are saved in the first application file. Therefore, it is possible to reduce time and effort when saving the data in the application file and to improve user convenience.

### Appendix 2

The display screen saving method according to Appendix 1, in which a first display image displayed on the display surface based on image data and a first drawn image displayed on the display surface based on an operation received by the display are displayed on the first screen by the display, the first data includes first capture data obtained by capturing the first display image and first drawing data generated based on the operation, a second display image displayed on the display surface based on image data and a second drawn image displayed on the display surface based on an operation received by the display are displayed on the second screen by the display, and the second data includes second capture data obtained by capturing the second display image and second drawing data generated based on the operation.

Accordingly, the display image and the drawing data generated based on the operation can be separately saved. Therefore, only the drawing data can be edited later, and the user convenience can be improved.

### Appendix 3

The display screen saving method according to Appendix 2, further including: determining, by the information processing terminal, whether at least one of a number, a character, and a symbol is included in at least one of the first drawing data and the second drawing data; and converting, by the information processing terminal, at least one of the number, the character, and the symbol into text data when at least one of the number, the character, and the symbol is included in at least one of the first drawing data and the second drawing data.

Accordingly, when the drawing data includes at least one of a number, a character, and a symbol, the number, the character, and the symbol are converted into the text data. Therefore, when the application file is read again later, the number, the character, and the symbol can be easily read.

### Appendix 4

The display screen saving method according to any one of Appendixes 1 to 3, in which the saving the first data in the first application file includes saving the first data in a background by the information processing terminal, and the saving the second data in the first application file includes saving the second data in a background by the information processing terminal.

Accordingly, the first data is saved in the first application file in the background, and the second data is saved in the first application file in the background. Therefore, even when the screen of the information processing terminal is displayed on the display, the display screen of the display surface is not switched, and the progress of classes, seminars, or the like is not hindered.

### Appendix 5

The display screen saving method according to any one of Appendixes 1 to 4, further including: notifying that the first data is saved in the first application file by the information processing terminal when the first data is saved in the first application file; and notifying that the second data is saved in the first application file by the information processing terminal when the second data is saved in the first application file.

Accordingly, when the first data is saved in the first application file, the first data being saved is notified, and when the second data is saved in the first application file, the second data being saved is notified. Therefore, the user can recognize that the saving of the data is completed.

### Appendix 6

The display screen saving method according to any one of Appendixes 1 to 5, further including: receiving, by the information processing terminal, an end operation of closing the first application file; causing, by the information processing terminal, a storage device included in the information processing terminal to store the first application file; receiving, by the display, a capture request for a third screen displayed on the display surface by the display; capturing, by the display, the third screen to generate third data; transmitting, by the display, the third data to the information processing terminal; and saving, by the information processing terminal, the third data in a second application file different from the first application file.

Accordingly, when the capture request for the third display screen is received after the end operation is received, the third data is saved in the second application file different from the first application file. Therefore, the application file for saving the data can be changed.

### Appendix 7

The display screen saving method according to any one of Appendixes 1 to 6, further including: receiving, by the information processing terminal, discoupling of a network coupling between the information processing terminal and the display; causing, by the information processing terminal, a storage device included in the information processing terminal to store the first application file; receiving, by the display, a capture request for a third screen displayed on the display surface by the display; capturing, by the display, the third screen to generate third data; transmitting, by the display, the third data to the information processing terminal; and saving, by the information processing terminal, the third data in a second application file different from the first application file.

Accordingly, when the network coupling between the information processing terminal and the display is discoupled, when the capture request for the third display screen is received after the end operation is received, the third data is saved in the second application file different from the first application file. Therefore, the application file for saving the data can be changed.

### Appendix 8

The display screen saving method according to Appendix 1, in which a first drawn image displayed on the display surface based on an operation received by the display is displayed on the first screen by the display, the first data includes first drawing data generated based on the operation, a second drawn image displayed on the display surface based on an operation received by the display is displayed on the second screen by the display, and the second data includes second drawing data generated based on the operation.

Accordingly, the first data obtained by capturing the first drawing data and the second data obtained by capturing the second drawing data are saved in the first application file. Therefore, it is possible to reduce time and effort when saving the data in the application file and to improve user convenience.

### Appendix 9

A display system including: an information processing terminal; and a display configured to display a display screen on a display surface, in which the display includes a first communicator, a receiver configured to receive an operation, an optical device configured to display the display screen on the display surface, and a first controller configured to receive, by the receiver, a capture request for a first screen displayed on the display surface by the optical device, capture the first screen to generate first data, transmit the first data to the information processing terminal by the first communicator, receive, by the receiver, a capture request for a second screen displayed on the display surface by the optical device, capture the second screen to generate second data, and transmit the second data to the information processing terminal by the first communicator, and the information processing terminal includes a second communicator, and a second controller configured to save the first data received from the display by the second communicator in a first application file and store the second data received from the display by the second communicator in the first application file.

Accordingly, first data obtained by the capturing the first display screen and the second data obtained by capturing the second display screen are saved in the first application file. Therefore, it is possible to reduce time and effort when saving the data in the application file and to improve user convenience.

What is claimed is:

1. A display screen saving method comprising:
receiving, by a display, a capture request for a first screen displayed on a display surface by the display;
capturing the first screen by the display to generate first data;
transmitting the first data to an information processing terminal by the display;
saving the first data in a first application file by the information processing terminal;
receiving, by the display, a capture request for a second screen displayed on the display surface by the display;
capturing the second screen by the display to generate second data;
transmitting the second data to the information processing terminal by the display; and
saving the second data in the first application file by the information processing terminal.

2. The display screen saving method according to claim 1, wherein
a first display image displayed on the display surface based on image data and a first drawn image displayed on the display surface based on an operation received by the display are displayed on the first screen by the display,
the first data includes first capture data obtained by capturing the first display image and first drawing data generated based on the operation,
a second display image displayed on the display surface based on image data and a second drawn image displayed on the display surface based on an operation received by the display are displayed on the second screen by the display, and
the second data includes second capture data obtained by capturing the second display image and second drawing data generated based on the operation.

3. The display screen saving method according to claim 2, further comprising:
determining, by the information processing terminal, whether at least one of a number, a character, and a symbol is included in at least one of the first drawing data and the second drawing data; and
converting, by the information processing terminal, at least one of the number, the character, and the symbol into text data when at least one of the number, the character, and the symbol is included in at least one of the first drawing data and the second drawing data.

4. The display screen saving method according to claim 1, wherein
the saving the first data in the first application file includes saving the first data in a background by the information processing terminal, and
the saving the second data in the first application file includes saving the second data in a background by the information processing terminal.

5. The display screen saving method according to claim 1, further comprising:
notifying that the first data is saved in the first application file by the information processing terminal when the first data is saved in the first application file; and
notifying that the second data is saved in the first application file by the information processing terminal when the second data is saved in the first application file.

6. The display screen saving method according to claim 1, further comprising:
receiving, by the information processing terminal, an end operation of closing the first application file;
causing, by the information processing terminal, a storage device included in the information processing terminal to store the first application file;
receiving, by the display, a capture request for a third screen displayed on the display surface by the display;
capturing, by the display, the third screen to generate third data;
transmitting, by the display, the third data to the information processing terminal; and
saving, by the information processing terminal, the third data in a second application file different from the first application file.

7. The display screen saving method according to claim 1, further comprising:
receiving, by the information processing terminal, discoupling of a network coupling between the information processing terminal and the display;
causing, by the information processing terminal, a storage device included in the information processing terminal to store the first application file;
receiving, by the display, a capture request for a third screen displayed on the display surface by the display;
capturing, by the display, the third screen to generate third data;
transmitting, by the display, the third data to the information processing terminal; and
saving, by the information processing terminal, the third data in a second application file different from the first application file.

8. The display screen saving method according to claim 1, wherein
a first drawn image displayed on the display surface based on an operation received by the display is displayed on the first screen by the display,
the first data includes first drawing data generated based on the operation,
a second drawn image displayed on the display surface based on an operation received by the display is displayed on the second screen by the display, and
the second data includes second drawing data generated based on the operation.

9. A display system comprising:
an information processing terminal; and
a display configured to display a display screen on a display surface, wherein
the display includes
a first communicator,
a receiver configured to receive an operation,
an optical device configured to display the display screen on the display surface, and
a first controller configured to receive, by the receiver, a capture request for a first screen displayed on the display surface by the optical device,
capture the first screen to generate first data,
transmit the first data to the information processing terminal by the first communicator,
receive, by the receiver, a capture request for a second screen displayed on the display surface by the optical device,
capture the second screen to generate second data, and
transmit the second data to the information processing terminal by the first communicator, and
the information processing terminal includes
a second communicator, and
a second controller configured to save the first data received from the display by the second communicator in a first application file and save the second data received from the display by the second communicator in the first application file.
